(19) United States
(12) Patent Application Publication
(10) Pub. No.: US 2009/0316202 A1
(43) Pub. Date: Dec. 24, 2009

(54) DATA PROCESSING APPARATUS WHICH DOWNLOADS DATA VIA NETWORK, DATA PROCESSING METHOD, AND DATA PROCESSING PROGRAM EMBODIED ON COMPUTER READABLE MEDIUM

(75) Inventor: Atsushi UEDA, Ritto-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Chiyoda-ku (JP)

(21) Appl. No.: 12/486,895

(22) Filed: Jun. 18, 2009

(30) Foreign Application Priority Data
Jun. 20, 2008 (JP) 2008-161143

(51) Int. Cl. G06F 3/12

(52) U.S. Cl. 358/1.15

(57) ABSTRACT

In order to facilitate designating page data, an MFP includes an operation portion to accept a user operation, the operating portion having a plurality of keys, a data acquiring portion to acquire a Web page written in a markup language, an extracting portion to extract link information included in the acquired Web page, and an assigning portion to assign to at least one of the plurality of keys an assignment command to execute a process on data stored in a link destination which is specified by the extracted link information.

This application is based on Japanese Patent Application No. 2008-161143 filed with Japan Patent Office on Jun. 20, 2008, the entire content of which is hereby incorporated by reference

### BACKGROUND OF THE INVENTION

1. Field of the Invention

The present invention relates to a data processing apparatus, a data processing method, and a data processing program embodied on a computer readable medium. More particularly, the present invention relates to a data processing apparatus which downloads data via a network, and a data processing method and a data processing program embodied on a computer readable medium which are executed in the data processing apparatus.

2. Description of the Related Art

Recently, a composite machine called a multi function peripheral (MFP) provided with scanning, printing, copying, and facsimile transmitting/receiving functions may also be provided with a browsing function. Such an MFP may be connected to the Internet to download a Web page from a Web server and the like for display. The MFP may also include a touch panel superimposed on a liquid crystal display (LCD) for simple and easy operations. When a Web page is displayed on the LCD, a user may operate the MFP by touching the touch panel with a finger and the like to designate the area where information indicating a link source is displayed.

The LCD included in the MFP, however, is smaller in size than the one included in a personal computer and the like, and therefore, the area for displaying the information indicating the link source may be too small to be touched with a finger. Particularly in the case where a plurality of areas in which information indicating different link sources is displayed is densely arranged, it will be very difficult for the user to designate a desired one of these areas.

### SUMMARY OF THE INVENTION

The present invention has been accomplished in view of the foregoing problems, and an object of the present invention is to provide a data processing apparatus which facilitates designating page data.

Another object of the present invention is to provide a data processing apparatus capable of notifying a user of information associated with data stored in the link destination.

A further object of the present invention is to provide a data processing method and a data processing program embodied on a computer readable medium which facilitate designating page data.

Yet another object of the present invention is to provide a data processing method and a data processing program embodied on a computer readable medium which are capable of notifying a user of information associated with data stored in the link destination.

In order to achieve the above-described objects, according to an aspect of the present invention, a data processing apparatus includes: an operation accepting portion to accept an operation of a user, the operation accepting portion having a plurality of keys; a data acquiring portion to acquire page data written in a markup language; an extracting portion to extract link information which is included in the acquired page data; and an assigning portion to assign to at least one of the plurality of keys an assignment command to execute a process on data stored in a link destination which is specified by the extracted link information.

According to another aspect of the present invention, a data processing apparatus includes: a data acquiring portion to acquire page data written in a markup language; an extracting portion to extract link information which is included in the acquired page data; a searching portion to search for related data which is related to data stored in a link destination which is specified by the extracted link information; a related data acquiring portion, when the related data is found, to acquire the related data; and a related data arranging portion to arrange the acquired related data in the acquired page data in such a manner that the related data is displayed near a position where information indicating a link source included in the extracted link information is displayed.

According to a further aspect of the present invention, a data processing method is carried out in a computer, the computer including an operation accepting portion to accept an operation of a user, the operation accepting portion having a plurality of keys, wherein the method includes the steps of: acquiring page data which is written in a markup language; extracting link information which is included in the acquired page data; and assigning to at least one of the plurality of keys an assignment command to execute a process on data stored in a link destination which is specified by the extracted link information.

According to a still further aspect of the present invention, a data processing method includes the steps of: acquiring page data which is written in a markup language; extracting link information which is included in the acquired page data; searching for related data which is related to data stored in a link destination which is specified by the extracted link information; when the related data is found, acquiring the related data; and arranging the acquired related data in the acquired page data in such a manner that the related data is displayed near a position where information indicating a link source included in the extracted link information is displayed.

According to yet another aspect of the present invention, a data processing program embodied on a computer readable medium is executed by a computer including an operation accepting portion to accept an operation of a user, the operation accepting portion having a plurality of keys, wherein the program causes the computer to execute the steps of: acquiring page data which is written in a markup language; extracting link information which is included in the acquired page data; and assigning to at least one of the plurality of keys an assignment command to execute a process on data stored in a link destination which is specified by the extracted link information.

According to yet another aspect of the present invention, a data processing program embodied on a computer readable medium causes a computer to execute the steps of: acquiring page data which is written in a markup language; extracting link information which is included in the acquired page data; searching for related data which is related to data stored in a link destination which is specified by the extracted link information; when the related data is found, acquiring the related data; and arranging the acquired related data in the acquired page data in such a manner that the related data is displayed near a position where information indicating a link source included in the extracted link information is displayed.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram showing an information processing system according to an embodiment of the present invention.

FIG. 2 is a perspective view of an MFP.

FIG. 3 is a block diagram showing an example of the circuit configuration of the MFP.

FIG. 4 is a plan view showing an example of an operation panel.

FIG. 5 is a functional block diagram showing an example of the functions of a CPU included in the MFP according to a first embodiment of the present invention.

FIGS. 6A and 6B are first diagrams showing examples of the display state of a Web page.

FIG. 7 is a first flowchart illustrating an example of the flow of conversion processing.

FIG. 8 is a functional block diagram showing an example of the functions of the CPU included in the MFP according to a second embodiment of the present invention.

FIG. 9 is a second diagram showing an example of the display state of a Web page.

FIG. 10 is a second flowchart illustrating an example of the flow of the conversion processing.

### DESCRIPTION OF THE PREFERRED EMBODIMENTS

Embodiments of the present invention will now be described with reference to the drawings. In the following description, like reference characters denote like parts, which have like names and functions, and therefore, detailed description thereof will not be repeated.

### First Embodiment

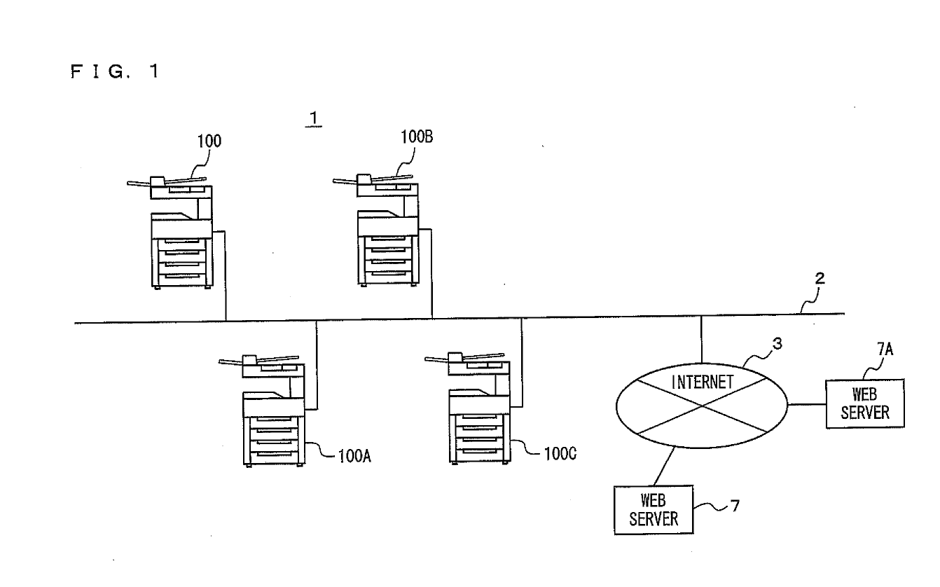

FIG. 1 schematically shows an information processing system according to an embodiment of the present invention. Referring to FIG. 1, an information processing system 1 includes composite machines (hereinafter, referred to as “MFPs”) 100, 100A, 100B, and 100C, which are connected to a network 2. MFPs 100, 100A, 100B, and 100C are examples of a data processing apparatus, which is provided with a plurality of functions such as scanning, printing, copying, and facsimile transmitting/receiving functions.

Network 2 is a local area network (LAN), which may be connected in a wired or wireless manner. Network 2 is not necessarily the LAN; it may be a wide area network (WAN), public switched telephone networks (PSTN), and the like. Network 2 is connected to the Internet 3 via a gateway. MFPs 100, 100A, 100B, and 100C are capable of communicating with Web servers 7, 7A which are connected to Internet 3.

MFPs 100, 100A, 100B, and 100C are capable of executing a browsing program; i.e., they each have the browsing function. For example, when a user designates a uniform resource locator (URL) of a Web page stored in Web server 7, MFP 100 requests transmission of the Web page specified by the URL from Web server 7, and receives and displays the Web page transmitted from Web server 7. Hereinafter, the process carried out by MFPs 100, 100A, 100B, and 100C to download and display a Web page will be called a “browsing process”.

While MFPs 100, 100A, 100B, and 100C will be described as examples of the data processing apparatus in the present embodiment, the data processing apparatus is not limited to MFPs 100, 100A, 100B, and 100C, and may be any apparatus provided with the browsing function, such as a personal computer, scanner, printer, or facsimile machine. MFPs 100, 100A, 100B, and 100C are provided with the same functions, and thus, MFP 100 will be described representatively.

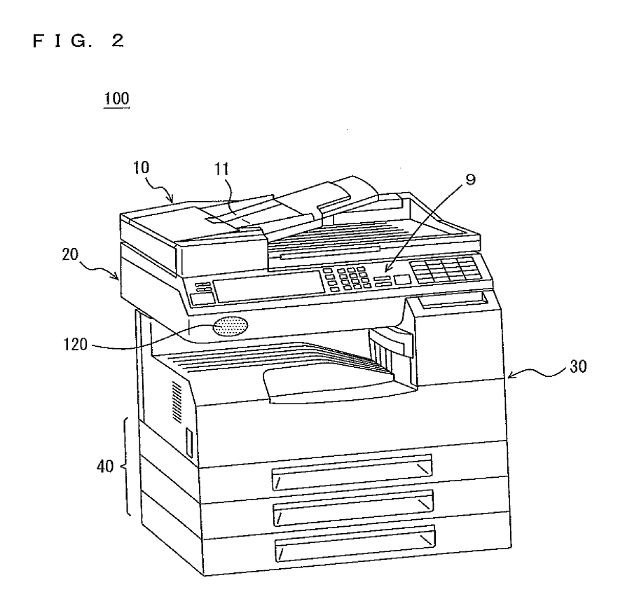

FIG. 2 is a perspective view of the MFP. Referring to FIG. 2, MFP 100 includes an automatic document feeder (ADF) 10, an image reading portion 20, an image forming portion 30, and a paper feeding portion 40.

ADF 10 automatically carries a plurality of documents set in a document feed tray 11 one by one to a predetermined document reading position set on a platen glass of image reading portion 20, and discharges the documents for which the images were read by image reading portion 20 to a document output tray. Image reading portion 20 includes a light source for illuminating the document delivered to the document reading position with light, and a photoelectric conversion element for receiving the light reflected from the document. Image reading portion 20 scans the image of the document in accordance with the size of the document. The photoelectric conversion element converts the received light into electric signals, or image data, and outputs the image data to image forming portion 30. Paper feeding portion 40 carries sheets of paper stored in a paper feed tray to image forming portion 30.

Image forming portion 30 forms an image using well-known electrophotography. It performs various kinds of data processing, including shading compensation, on the image data input from image reading portion 20, to form an image on the sheet of paper carried from paper feeding portion 40, based on the image data on which the data processing has been performed.

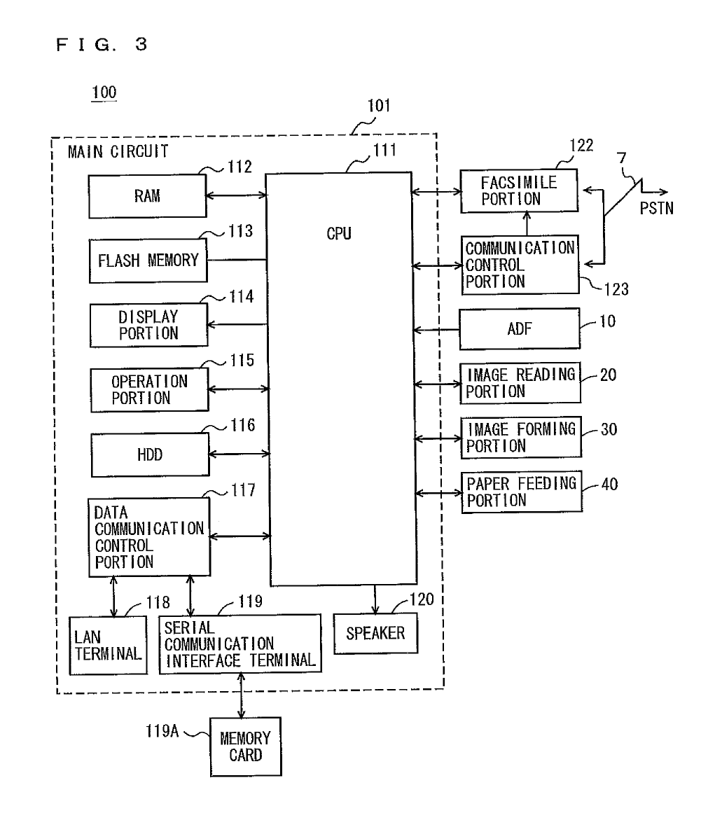

FIG. 3 is a block diagram showing an example of the circuit configuration of the MFP. Referring to FIG. 3, MFP 100 includes a main circuit 101, a facsimile portion 122, and a communication control portion 123. Main circuit 101 includes a central processing unit (CPU) 111, a random access memory (RAM) 112 used as a work area for CPU 111, a flash memory 113 for storing a program executed by CPU 111 and the like, a display portion 114, an operation portion 115, a hard disk drive (HDD) 116 serving as a mass storage, a data communication control portion 117, and a speaker 120 for outputting a sound.

CPU 111 carries out various kinds of processing by executing the programs stored in flash memory 113. Flash memory 113 is an electrically erasable and programmable read only memory (EEPROM).

CPU 111 is connected with display portion 114, operation portion 115, HDD 116, and data communication control portion 117, and is responsible for overall control of main circuit 101. Further, CPU 111 is connected with facsimile portion 122, communication control portion 123, ADF 10, image reading portion 20, image forming portion 30, and paper feeding portion 40, and is responsible for overall control of MFP 100.

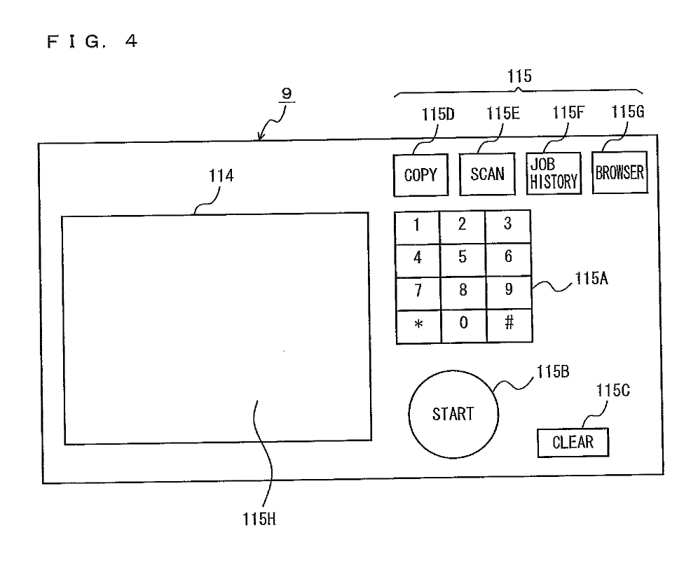

Display portion 114 is a display such as a liquid crystal display (LeD), an organic electro-luminescence display (organic ELD) or the like, and displays an instruction menu for the user, information about acquired image data, and others. Operation portion 115, which is provided with a plurality of keys, accepts data input such as instructions, characters, and numerical characters, according to the key operations by the user. Operation portion 115 includes a touch panel 115H provided on display portion 114 (see FIG. 4). Touch panel 115H may be a resistive film-type touch panel or a surface acoustic wave-type touch panel, although it is not particularly restricted thereto. Touch panel 115H detects the position pointed by a finger or a stylus pen, and outputs the coordinates of the detected position to CPU 111. Display portion 114 and operation portion 115 substantially constitute an operation panel 9 provided on an upper surface of MFP 100.

Data communication control portion 117 includes a LAN terminal 118 which is an interface for communication according to a communication protocol such as transmission control protocol (TCP) or user datagram protocol (UDP), and a serial communication interface terminal 119 for serial communication. Data communication control portion 117 transmits and receives data to and from an external device connected to LAN terminal 118 or serial communication interface terminal 119, in accordance with an instruction from CPU 111.

When a LAN cable for connection to network 2 is connected to LAN terminal 118, data communication control portion 117 communicates with other MFPs 100A, 100B, and 100C connected to network 2, via LAN terminal 118. Data communication control portion 117 also communicates with Web servers 7, 7A connected to Internet 3.

CPU 111 controls data communication control portion 117 to download a program from a computer connected to network 2 or Internet 3 and store the program in flash memory 113, which enables updating of the program. The program includes a data processing program, which will be described later.

A memory card 119A with a flash memory built therein may be connected to serial communication interface terminal 119. CPU 111 controls data communication control portion 117 to read from memory card 119A the program to be executed by CPU 111 and store the program in flash memory 113, whereby the program can be updated.

It is noted that the recording medium for storing the program to be executed by CPU 111 is not restricted to memory card 119A. It may be a flexible disk, a cassette tape, an optical disc (compact disc-ROM (CD-ROM), magneto-optical (MO) disc, mini disc (MD), digital versatile disc (DVD)), an IC card (including a memory card), an optical card, or a semiconductor memory such as a mask ROM, an erasable and programmable ROM (EPROM), an EEPROM, or the like.

Alternatively, CPU 111 may download the program from a computer connected to network 2 and store the program in flash memory 113, or a computer connected to network 2 may write the program to flash memory 113, and thereafter, the program stored in flash memory 113 may be loaded to RAM 112 for execution by CPU 111. As used herein, the “program” includes, not only the program which CPU 111 can execute directly, but also a source program, a compressed program, an encrypted program, and others.

Communication control portion 123 is a modem for connecting CPU 111 to public switched telephone networks (PSTN) 7. MFP 100 has a pre-assigned telephone number in PSTN 7. When a call is originated from a facsimile machine connected to PSTN 7 to the telephone number assigned to MFP 100, communication control portion 123 detects the call. Upon detection of the call, communication control portion 123 establishes connection between the facsimile machine and MFP 100 to cause facsimile portion 122 to communicate with the facsimile machine.

Facsimile portion 122 is connected to PSTN 7, and transmits facsimile data to or receives facsimile data from PSTN 7. Speaker 120 is provided on a front side of MFP 100, and is controlled by CPU 111 to output a sound.

FIG. 4 is a plan view showing an example of the operation panel. Referring to FIG. 4, operation panel 9 includes display portion 114 and operation portion 115. Operation portion 115 includes: a ten-key pad 115A; a start key 115B; a clear key 115C for canceling the input content; a copy key 115D for causing MFP 100 to enter a copy mode for execution of a copying process; a scan key 115E for causing MFP 100 to enter a scan mode for execution of a scanning process; a job history key 115F for displaying a job history; and a browser key 115G for causing MFP 100 to enter a browsing mode for execution of a browsing process.

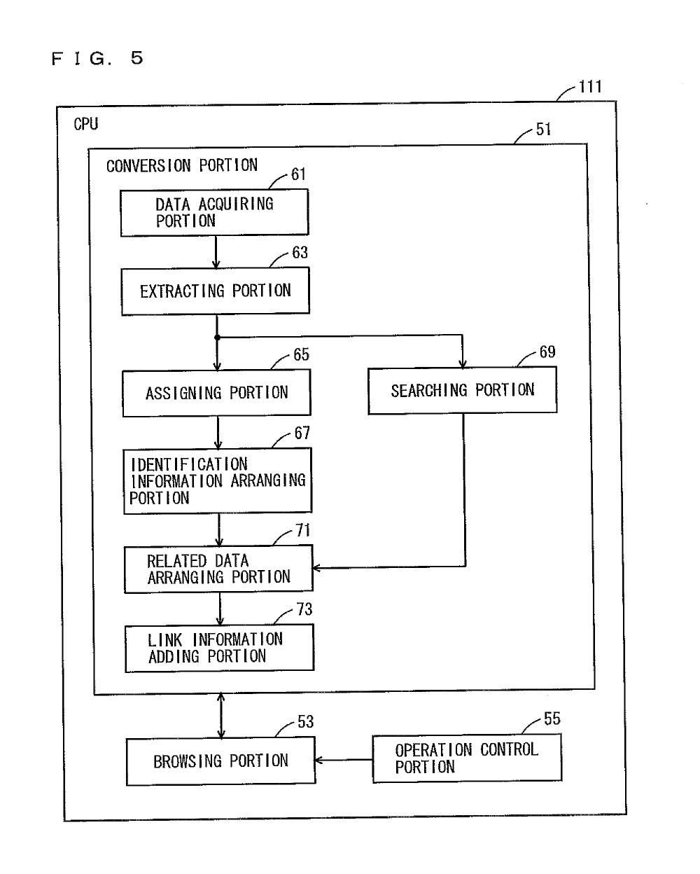

FIG. 5 is a functional block diagram schematically showing the functions of the CPU included in the MFP according to the first embodiment of the present invention. Referring to FIG. 5, CPU 111 includes a browsing portion 53 to display Web pages downloaded from Web servers 7, 7A, a conversion portion 51 to download and convert a Web page for which downloading was instructed by browsing portion 53, and an operation control portion 55 to control operation portion 115.

Browsing portion 53 is formed in CPU 111 as CPU 111 executes a browsing program. When a user inputs to operation portion 115 a URL assigned to a Web page which is stored in one of Web servers 7, 7A, browsing portion 53 outputs a download instruction to data communication control portion 117 via conversion portion 51. The download instruction directs data communication control portion 117 to download the Web page specified by that URL from the corresponding one of Web servers 7, 7A. Browsing portion 53 acquires via conversion portion 51 the Web page received by data communication control portion 117, for display in display portion 114.

Conversion portion 51 is provided between browsing portion 53 and data communication control portion 117, so that conversion portion 51 receives a download instruction directed to data communication control portion 117 that is issued by browsing portion 53, and outputs the input download instruction to data communication control portion 117. Further, conversion portion 51 receives from data communication control portion 117 the Web page that data communication control portion 117 has received, converts the input Web page, and outputs the resultant Web page to browsing portion 53.

Conversion portion 51 includes: a data acquiring portion 61 to acquire a Web page (i.e., page data) based on a download instruction input from browsing portion 53; an extracting portion 63 to extract, from the Web page, link information included therein; an assigning portion 65 to assign a command to one of a plurality of keys included in operation portion 115; an identification information arranging portion 67 to arrange, in the Web page, identification information for identifying the key to which a command is assigned; a searching portion 69 to search for related data which is related to data stored in the link destination that is specified by the link information; a related data arranging portion 71 to arrange, in the Web page, the related data that has been found; and a link information adding portion 73 to add new link information to the Web page.

Data acquiring portion 61 receives a download instruction directed to data communication control portion 117 that is issued by browsing portion 53, and outputs the received download instruction to data communication control portion 117. The download instruction includes a URL that a user inputs to operation portion 115. Upon receipt of the download instruction, data communication control portion 117 downloads the Web page specified by the URL included in the download instruction from one of Web servers 7, 7A, and outputs the downloaded Web page to CPU 111. Data acquiring portion 61 receives the Web page that data communication control portion 117 has received, and outputs the Web page to extracting portion 63.

Extracting portion 63 extracts, from the Web page input from data acquiring portion 6l, the link information included therein. The link information includes: information indicating the link source; and a URL assigned to the data stored in the link destination. In a markup language, the way of describing the link information is predetermined. For example, the information indicating the link source may be a character string or an image.

Extracting portion 63 outputs the extracted link information to assigning portion 65 and searching portion 69. In the case where a plurality of link information items is extracted, extracting portion 63 outputs the extracted link information items to assigning portion 65 and searching portion 69. It is noted that each of assigning portion 65, identification information arranging portion 67, related data arranging portion 71, and link information adding portion 73 processes each of the plurality of link information items in the same manner. Thus, unless otherwise specified, it is here assumed that a single link information item is extracted.

Assigning portion 65 generates an assignment command to execute a process on the data stored in the link destination that is specified by the link information, and assigns the generated assignment command to one of a plurality of keys included in operation portion 115. Specifically, it generates an assignment command to download the data stored in the link destination included in the link information to displays it on display portion 114, and assigns the assignment command to one of the keys included in operation portion 115, which may be, e.g., the “1” key in ten-key pad 115A. Here, the assignment command to download the data stored in the link destination included in the link information to display it on display portion 114 is particularly called an “acquisition command”.

Assigning portion 65 generates a program to execute an assignment command upon designation of a key to which the command is assigned, and adds the generated program to the Web page to thereby assign the assignment command to the corresponding key. It is noted that the program to execute the assignment command when a key to which the command is assigned is designated may be stored in RAM 112, rather than being added to the Web page. In this case, operation control portion 55 may execute the command assigned to the pressed key among the plurality of keys included in operation portion 115.

In the case where a plurality of link information items is input from extracting portion 63, assigning portion 65 generates a plurality of assignment commands corresponding respectively to the plurality of link information items, and assigns the assignment commands to the plurality of keys included in operation portion 115, e.g., to the “1” to “9” keys in ten-key pad 115A. The commands may be assigned to the numeric keys in ten-key pad 115A in an ascending order thereof, as the link information items are extracted sequentially. Assigning portion 65 outputs a set of the link information and the identification information for identifying the key to which a command generated from that link information is assigned, to identification information arranging portion 67. While it is here assumed that a command is assigned to a key in ten-key pad 115A included in operation portion 115, it may be assigned to any key other than the keys in ten-key pad 115A.

Upon receipt of the set of the link information and the identification information, identification information arranging portion 67 adds the identification information to the Web page which is acquired by data acquiring portion 61. The identification information is arranged, in the Web page, near the information indicating the link source which is included in the link information paired with the identification information. As a result, when a Web page is displayed on display portion 114, the identification information for a key in the ten-key pad is displayed near the information indicating the link source, which can notify the user that the user may designate the key corresponding to the identification information, instead of designating the information indicating the link source.

Searching portion 69 searches for the related data which is related to the data stored in the link destination which is specified by the link information input from extracting portion 63. Searching portion 69 outputs a set of the related data that has been found by the search and the link information that has been input from extracting portion 63, to related data arranging portion 71. The related data may be, e.g., a thumbnail which is a reduced-size version of an image for the data stored in the link destination. Searching portion 69 searches, as the related data, for the data which has a file name identical to that of the data stored in the link destination specified by the link information, except for the extension of the file name. If such related data is found, searching portion 69 acquires the related data. It may be configured to request a computer in which the related data is stored to retrieve the data, to acquire the related data from that computer. In the case where there is a computer which stores a table in which the data stored in the link destination specified by the link information is associated with the related data, the table may be acquired from that computer to thereby acquire the related data which is associated with the data stored in the link destination by the acquired table.

Upon receipt of the set of the related data and the link information from searching portion 69, related data arranging portion 71 adds an image of the related data to the Web page acquired by data acquiring portion 61. The image of the related data is arranged, in the Web page, near the information indicating the link source which is included in the link information paired with the related data. As a result, when the Web page is displayed on display portion 114, the image of the related data is displayed near the information indicating the link source, so that the user can be notified of the information related to the data stored in the link destination. Related data arranging portion 71 outputs the set of the related data and the link information to link information adding portion 73.

Link information adding portion 73 adds new link information to the Web page acquired by data acquiring portion 61, wherein the new link information includes, as information indicating the link source, the related data arranged in the Web page by related data arranging portion 71, and also includes a URL assigned to the data stored in the link destination that is specified by the link information. As a result, if the image of the related data displayed in the Web page is designated while the Web page is displayed on display portion 114 by browsing portion 53, the data stored in the link destination is downloaded and displayed.

Operation control portion 55 controls operation portion 115. When a user designates a key in operation portion 115, operation control portion 55 accepts identification information for identifying the designated key, whereas when the user designates touch panel 115H in operation portion 115, operation control portion 55 accepts positional information indicating the designated position on touch panel 115H. Operation control portion 55 outputs the accepted identification information or positional information to browsing portion 53.

Browsing portion 53 displays the Web page input from conversion portion 51 on display portion 114. The Web page input from conversion portion 51 includes a program, which is executed by browsing portion 53. When a key to which an assignment command is assigned is designated, browsing portion 53 downloads the data specified by the program, which is in this example the data stored in the link destination included in the link information included in the Web page, for display on display portion 114. The Web page input from conversion portion 51 further includes the identification information for the key to which the assignment command is assigned, which information is arranged near the information indicating the link source.

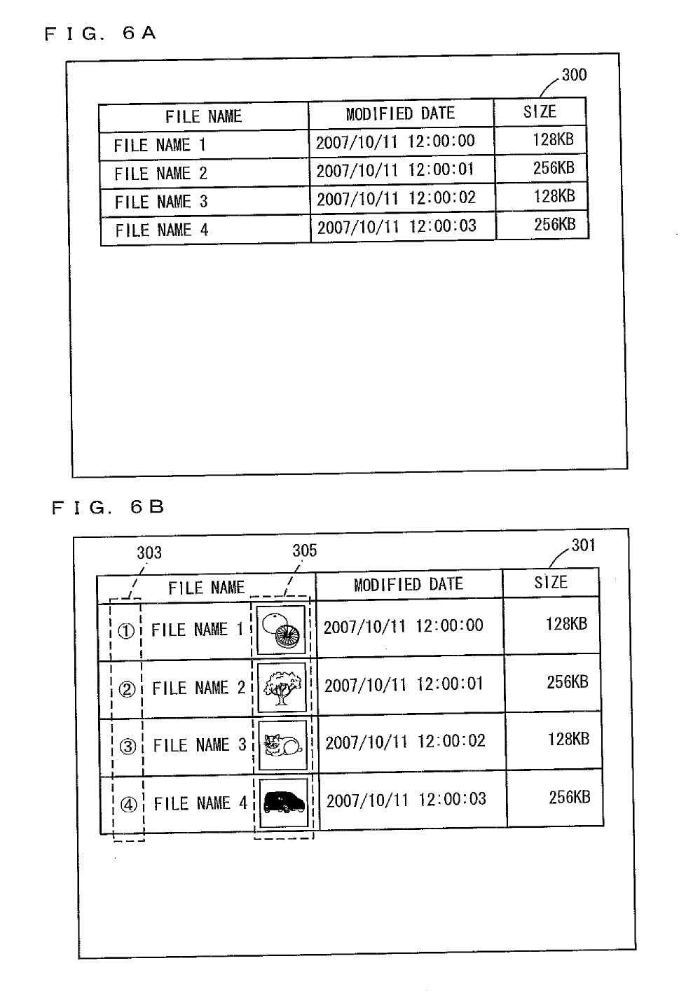

FIGS. 6A and 6B are first diagrams showing examples of the display state of the Web page. FIG. 6A shows a display state of the Web page before conversion. The Web page includes a link information table 300 including information regarding the data stored in the link destination, and link information table 300 is displayed when the Web page is displayed. Link information table 300 includes the fields of “File Name”, “Modified Date”, and “Size”. Displayed in the “File Name” field, which is the information indicating the link source, is a file name of the data stored in the link destination. Displayed in the “Modified Date” field is the date and time at which the data stored in the link destination has been updated. In the “Size” field, the size of the data stored in the link destination is displayed. The Web page input from conversion portion 51 further includes an image of the related data, which is displayed near the information indicating the link source. The image of the related data is linked to the data stored in the link destination.

FIG. 6B shows a display state of the Web page after conversion. The converted Web page includes a link information table 301, which differs from link information table 300 included in the Web page before conversion in that identification information 303 for the key to which an assignment command is assigned is displayed on the left side of the file name (information indicating the link source) displayed in the “File Name” field, and an image 305 of the related data is displayed on the right side of the file name (information indicating the link source) displayed in the “File Name” field. It is noted that the broken lines are added in the figure merely for convenience of explanation, which do not appear on the actual screen.

Identification information 303 displayed on the left side of the file name (information indicating the link source) facilitates the user's operation, because the user may designate one of the plurality of keys included in operation portion 115 that is specified by the identification information, instead of designating the file name which is the information indicating the link source on touch panel 115H. Further, the user can look at the identification information displayed on the left side of the file name (information indicating the link source) to determine the key to be designated instead of designating the file name on touch panel 115H, which also facilitates the user's operation. Furthermore, image 305 of the related data is displayed on the right side of the file name (information indicating the link source), which allows the user to grasp from the image the content of the information related to the linked data. The user may designate image 305 of the related data displayed relatively larger in size than the file name, instead of designating the file name on touch panel 115H, which further facilitates the user's operation.

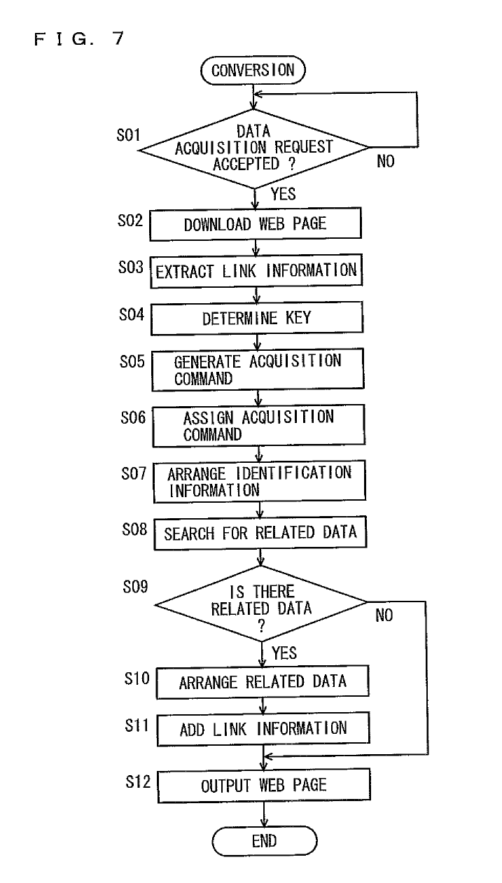

FIG. 7 is a first flowchart illustrating an example of the flow of conversion processing. The conversion processing is carried out by CPU 111 included in MFP 100 as CPU 111 executes a data processing program. Referring to FIG. 7, CPU 111 determines whether a data acquisition request has been accepted (step S01). CPU 111 is in a standby mode until a data acquisition request is accepted (NO in step S01), and once the data acquisition request is accepted, the process proceeds to step S02. Specifically, when a download instruction is output from a browsing program which CPU 111 executes together with the data processing program, the download instruction is accepted as the data acquisition request. That is, the conversion processing is carried out provided that CPU 111 executing the browsing program outputs the data acquisition request.

In step S02, the Web page specified by the URL included in the data acquisition request is downloaded. CPU 111 acquires the data specified by the URL by requesting one of Web servers 7, 7A connected to Internet 3 that is specified by the URL to download the data.

CPU 111 then extracts link information from the downloaded Web page (step S03). In the case where the Web page includes a plurality of link information items, it acquires all the link information items. When a plurality of link information items is extracted, steps S04 to S11 are carried out for each of the link information items.

In the following step S04, one of the plurality of keys 115A to 115G included in operation portion 115 is determined. Here, among the keys in ten-key pad 11A, the one with the smallest number is determined. In step S05, an acquisition command to download the data stored in the link destination included in the extracted link information and display the downloaded data on display portion 114 is generated. The acquisition command defines, e.g., a process of passing the URL assigned to the data stored in the link destination to a process that is generated by causing CPU 111 to execute the browsing program.

In the following step S06, the acquisition command is assigned to the key determined in step S04. Specifically, the program for executing the acquisition command when the corresponding key is designated is generated, and the generated program is added to the Web page acquired in step S02. This program is written, e.g., in a JAVA (registered trademark) script. As a result, when the key to which the acquisition command is assigned is designated, the process which is generated by causing CPU 111 to execute the browsing program carries out the program added to the Web page, whereby the acquisition command is executed.

In step S07, the identification information for the key to which the acquisition command is assigned is arranged, in the Web page, near the information indicating the link source which is included in the link information extracted in step S03. Specifically, the description displaying the identification information is added to the Web page which has been downloaded in step S02.

In the following step S08, the related data which is related to the data stored in the link destination specified by the link information extracted in step S03 is searched for. Specifically, the data having the file name in which a portion other than the extension is identical to that of the data stored in the link destination specified by the link information is searched for as the related data. Alternatively, in the case where a computer stores a table associating the data stored in the link destination specified by the link information with the related data, the table may be acquired from the computer to thereby acquire the related data which is associated with the data stored in the link destination by the table.

In the following step S09, it is determined whether there exists the related data. As a result of the search performed in step S08, if the related data is found, the process proceeds to step S10; otherwise, the process proceeds to step S12. In step S10, the related data is acquired, and an image of the related data is arranged, in the Web page acquired in step S02, near the information indicating the link source which is included in the link information acquired in step S03.

Then, new link information which has the related data as the information indicating the link source and also includes the URL assigned to the data stored in the link destination specified by the link information extracted in step S03 is added to the Web page acquired in step S02 (step S11). Specifically, link information having the related data as the information indicating the link source and including the URL assigned to the data stored in the link destination included in the link information extracted in step S03 is generated as the new link information, which is added to the Web page downloaded in step S02.

In the following step S12, the Web page is output before the conversion processing is terminated. The Web page is output to the process which is generated by causing CPU 111 to execute the browsing program.

### Modification

While the related data which is related to the data stored in the link destination specified by the link information is added to the Web page in the first embodiment, the related data does not necessarily have to be added to the Web page. In this case, searching portion 69, related data arranging portion 71, and link information adding portion 73 shown in FIG. 5 are unnecessary, and steps S08 to S11 in FIG. 7 are also unnecessary.

As described above, MFP 100 according to the present embodiment includes: operation portion 115 which has a plurality of keys and accepts a user operation; data acquiring portion 61 to acquire a Web page written in a markup language; extracting portion 63 to extract link information included in the acquired Web page; and assigning portion 65 which assigns to at least one of the plurality of keys an assignment command to execute a process on data stored in a link destination which is specified by the extracted link information. When the key to which the assignment command is assigned is designated, the assignment command is executed, and thus, the data stored in the link destination specified by the link information is processed. Accordingly, it is readily possible to instruct execution of a process on the data stored in the link destination which is specified by the link information included in the Web page.

Further, assigning portion 65 adds to the acquired Web page a command to execute the assignment command when the one of the plurality of keys to which the assignment command is assigned is designated. This makes it possible to assign a command to a key, without the need to modify the browsing program.

Furthermore, the assignment command includes an acquisition command to acquire the data stored in the link destination specified by the link information. It is thus possible to display the data stored in the link destination by designating the corresponding key.

MFP 100 of the present embodiment further includes identification information arranging portion 67 which arranges identification information for identifying the one of the plurality of keys to which the assignment command is assigned, in the acquired Web page, in such a manner that the identification information is displayed near the position where the information indicating the link source included in the link information is displayed. This can notify the user of the link information corresponding to the respective keys.

Furthermore, MFP 100 of the present embodiment further includes searching portion 69 to search for related data which is related to the data stored in the link destination specified by the link information and acquire the related data if any; and related data arranging portion 71 which arranges the acquired related data in the acquired Web page (page data) in such a manner that the related data is displayed near the position where the information indicating the link source included in the extracted link information is displayed. This can notify the user of the related data which is related to the data stored in the link destination.

Moreover, MFP 100 of the present embodiment further includes link information adding portion 73 which adds to the acquired Web page new link information which has the related data as information indicating the link source and which links the link source to the data stored in the link destination. Accordingly, when the Web page is displayed, the image of the related data is displayed, and an operation to designate that image enables the data stored in the link destination included in the link information to be downloaded.

### Second Embodiment

According to the first embodiment, MFP 100 generates an assignment command to process the data stored in the link destination specified by the link information, and assigns the generated assignment command to one of a plurality of keys included in operation portion 115. Thus, the assignment command is executed when the user presses the key to which the assignment command is assigned. By comparison, according to the second embodiment, the assignment command is a command to select data stored in the link destination which is specified by the link information, and MFP 100 allows the user to designate a process to be executed on the data stored in the link destination specified by the link information.

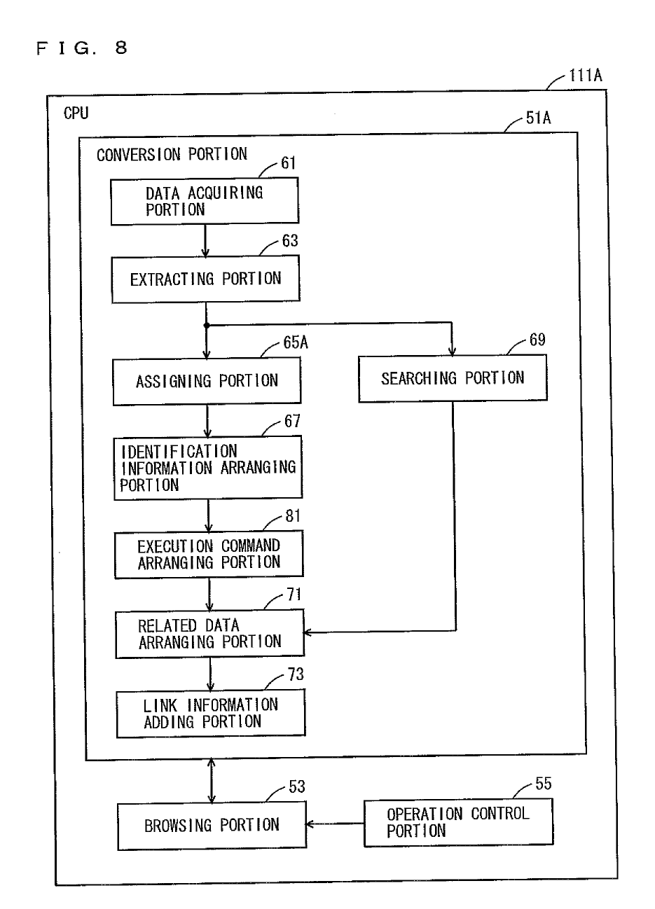

FIG. 8 is a functional block diagram schematically showing the functions of the CPU included in the MFP according to the second embodiment. The functional block diagram in FIG. 8 differs from the functional block diagram in FIG. 5 in that assigning portion 6SA has been modified and an execution command arranging portion 81 has been added.

Assigning portion 65A generates an assignment command to select data stored in the link destination which is included in the link information input from extracting portion 63, and assigns the assignment command to one of the plurality of keys included in operation portion 115. Here, the assignment command to select the data stored in the link destination included in the link information is particularly referred to as a “selection command”.

Execution command arranging portion 81 arranges, in the Web page acquired by data acquiring portion 61, a button to which an execution command is assigned, wherein the execution command is a command to download the data selected as a result of execution of the selection command and execute a predetermined process on the downloaded data. The button includes a process name for identifying the predetermined process. In the case where two or more processes are predetermined, two or more buttons corresponding respectively to the predetermined processes are arranged in the Web page.

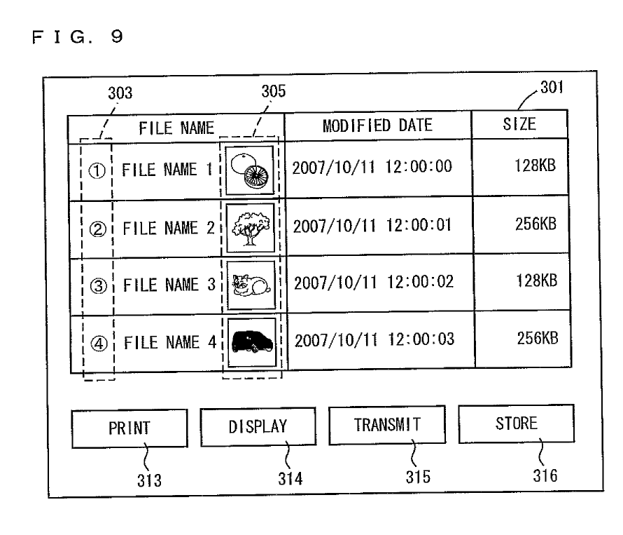

FIG. 9 is a second diagram showing an example of the display state of the Web page. The display state of the Web page shown in FIG. 9 differs from that shown in FIG. 6 in that buttons 313 to 316 to which execution commands are assigned have been added. Buttons 313 to 316 are assigned the commands to print, display, transmit, and store the selected data, respectively.

In the case where the user presses the “1” key in ten-key pad 115A included in operation portion 115, the data with the file name “File Name 1” is selected; if the user presses the “2” key, the data with the file name “File Name 2” is selected; if the user presses the “3” key, the data with the file name “File Name 3” is selected; and if the user presses the “4” key, the data with the file name “File Name 4” is selected. The user may select one or more data items. The file name may be highlighted to notify the user that the file name has been selected.

If the user designates button 313 after pressing at least one of the “1” to “4” keys, the selected data is downloaded and printed. If the user designates button 314 after pressing at least one of the “1” to “4” keys, the selected data is downloaded and displayed on display portion 114. If the user designates button 315 after pressing at least one of the “1” to “4” keys, the selected data is downloaded and transmitted to the outside. If the user designates button 316 after pressing at least one of the “1” to “4” keys, the selected data is downloaded and stored in HDD 116.

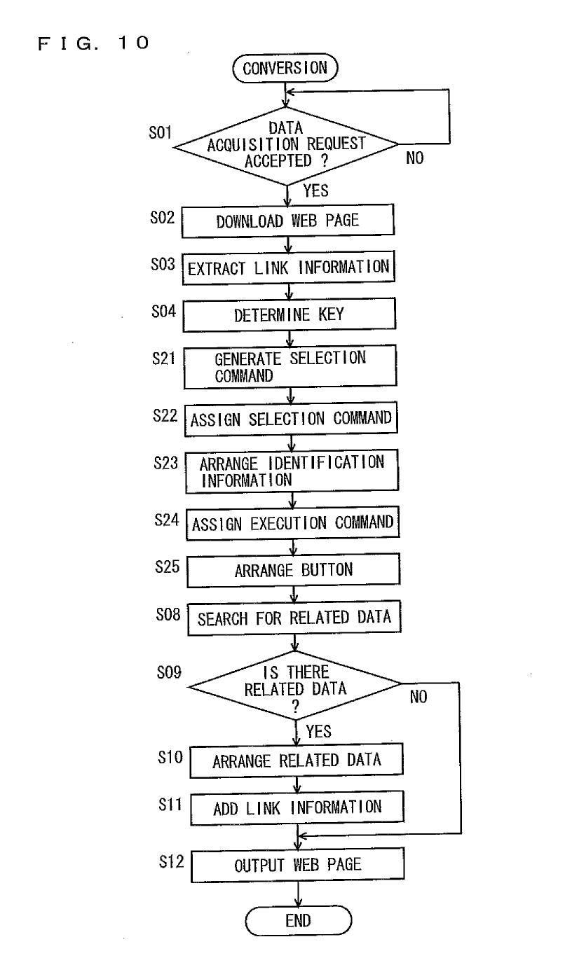

FIG. 10 is a second flowchart illustrating an example of the flow of the conversion processing. The conversion processing illustrated in FIG. 10 differs from the conversion processing illustrated in FIG. 7 in that steps S05 to S07 are replaced with steps S21 to S25. Otherwise, the processing is identical, and thus, description thereof will not be repeated.

In step S21, CPU 111 generates a selection command to select the data stored in the link destination included in the link information extracted in step S03 as a process target. In the following step S22, the selection command is assigned to the key determined in step S04. Here, it is assigned to a key in ten-key pad 115A. Specifically, a program for executing the selection command when the corresponding key is designated is generated, and the generated program is added to the Web page which has been acquired in step S02. As a result, when the key to which the acquisition command is assigned is designated, the process which is generated by causing CPU 111 to execute the browsing program carries out the program added to the Web page, whereby the selection command is executed.

In step S23, the identification information for the key to which the selection command has been assigned is arranged, in the Web page, near the information indicating the link source which is included in the link information extracted in step S03.

In the following step S24, the execution command is assigned to a button. Then, in step S25, the button to which the execution command has been assigned is arranged in the Web page. The button includes a process name of the predetermined process.

In MFP 100 according to the second embodiment, the assignment command includes a selection command to select the data stored in the link destination which is specified by the extracted link information, and MFP 100 further includes execution command arranging portion 81 which arranges, in the acquired Web page, four buttons to which four execution commands are assigned respectively, wherein the four execution commands are respectively for printing, displaying, transmitting, and storing the data which is selected as a result of execution of the selection command. Accordingly, designating one of the four buttons can cause the process corresponding to the designated button to be performed on the data stored in the link destination.

While MFP 100 has been described as an example of the data processing apparatus in the above embodiments, the present invention may of course be understood as a data processing method for causing a computer controlling MFP 100 to execute the processing shown in FIG. 7 or 10, or a data processing program for causing the computer to execute the data processing method.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A data processing apparatus comprising:
an operation accepting portion to accept an operation of a user, the operation accepting portion having a plurality of keys;
a data acquiring portion to acquire page data written in a markup language;
an extracting portion to extract link information which is included in said acquired page data; and
an assigning portion to assign, to at least one of said plurality of keys, an assignment command to execute a process on data stored in a link destination which is specified by said extracted link information.

2. The data processing apparatus according to claim 1, wherein said assigning portion adds to said acquired page data a command to execute said assignment command when the one of said plurality of keys to which said assignment command is assigned is designated.

3. The data processing apparatus according to claim 2, wherein said assignment command includes an acquisition command to acquire the data stored in the link destination which is specified by said extracted link information.

4. The data processing apparatus according to claim 2, wherein said assignment command includes a selection command to select the data stored in the link destination which is specified by said extracted link information.

5. The data processing apparatus according to claim 4, further comprising a command arranging portion to arrange, in said acquired page data, a button which is assigned an execution command to execute a predetermined process on the data selected as a result of execution of said selection command.

6. The data processing apparatus according to claim 1, further comprising an identification information arranging portion to arrange identification information for identifying the one of said plurality of keys to which said assignment command is assigned in said acquired page data in such a manner that said identification information is displayed near a position where the information indicating the link source included in said extracted link information is displayed.

7. The data processing apparatus according to claim 1, further comprising:
a searching portion to search for related data which is related to the data stored in the link destination which is specified by said extracted link information;
a related data acquiring portion, when said related data is found, to acquire the related data; and
a related data arranging portion to arrange said acquired related data in said acquired page data in such a manner that said related data is displayed near a position where the information indicating the link source included in said extracted link information is displayed.

8. A data processing apparatus comprising:
a data acquiring portion to acquire page data written in a markup language;
an extracting portion to extract link information which is included in said acquired page data;
a searching portion to search for related data which is related to data stored in a link destination which is specified by said extracted link information;
a related data acquiring portion, when said related data is found, to acquire the related data; and
a related data arranging portion to arrange said acquired related data in said acquired page data in such a manner that said related data is displayed near a position where information indicating a link source included in said extracted link information is displayed.

9. The data processing apparatus according to claim 8, further comprising a link information adding portion to add new link information to said acquired page data, the new link information having said related data as the information indicating the link source and linking the link source to said data stored in the link destination.

10. The data processing apparatus according to claim 8, wherein said searching portion searches for data which has identification information partially identical to the identification information for the data stored in the link destination which is specified by said extracted link information.

11. A data processing method carried out in a computer, the computer including an operation accepting portion to accept an operation of a user, the operation accepting portion having a plurality of keys, the method comprising the steps of:
acquiring page data which is written in a markup language;
extracting link information which is included in said acquired page data; and
assigning, to at least one of said plurality of keys, an assignment command to execute a process on data stored in a link destination which is specified by said extracted link information.

12. The data processing method according to claim 11, wherein said assigning step includes the step of adding to said acquired page data a command to execute said assignment command when the one of said plurality of keys to which said assignment command is assigned is designated.

13. The data processing method according to claim 11, further comprising the step of arranging identification information for identifying the one of said plurality of keys to which said assignment command is assigned in said acquired page data in such a manner that said identification information is displayed near a position where the information indicating the link source included in said extracted link information is displayed.

14. The data processing method according to claim 11, further comprising the steps of:
searching for related data which is related to the data stored in the link destination which is specified by said extracted link information;
when said related data is found, acquiring the related data; and
arranging said acquired related data in said acquired page data in such a manner that said related data is displayed near a position where the information indicating the link source included in said extracted link information is displayed.

15. A data processing method comprising the steps of
acquiring page data which is written in a markup language;
extracting link information which is included in said acquired page data;
searching for related data which is related to data stored in a link destination which is specified by said extracted link information;
when said related data is found, acquiring the related data; and
arranging said acquired related data in said acquired page data in such a manner that said related data is displayed near a position where information indicating a link source included in said extracted link information is displayed.

16. A data processing program embodied on a computer readable medium, the program being executed by a computer including an operation accepting portion to accept an operation of a user, the operation accepting portion having a plurality of keys, the program causing said computer to execute the steps of:
acquiring page data which is written in a markup language;
extracting link information which is included in said acquired page data; and
assigning, to at least one of said plurality of keys, an assignment command to execute a process on data stored in a link destination which is specified by said extracted link information.

17. The data processing program according to claim 16, wherein said assigning step includes the step of adding to said acquired page data a command to execute said assignment command when the one of said plurality of keys to which said assignment command is assigned is designated.

18. The data processing program according to claim 16, causing said computer to further execute the step of arranging identification information for identifying the one of said plurality of keys to which said assignment command is assigned in said acquired page data in such a manner that said identification information is displayed near a position where the information indicating the link source included in said extracted link information is displayed.

19. The data processing program according to claim 16, causing said computer to further execute the steps of:
searching for related data which is related to the data stored in the link destination which is specified by said extracted link information;
when said related data is found, acquiring the related data; and
arranging said acquired related data in said acquired page data in such a manner that said related data is displayed near a position where the information indicating the link source included in said extracted link information is displayed.

20. A data processing program embodied on a computer readable medium, the program causing a computer to execute the steps of:
acquiring page data which is written in a markup language;
extracting link information which is included in said acquired page data;
searching for related data which is related to data stored in a link destination which is specified by said extracted link information;
when said related data is found, acquiring the related data; and
arranging said acquired related data in said acquired page data in such a manner that said related data is displayed near a position where information indicating a link source included in said extracted link information is displayed.
